(19) United States
(12) Patent Application Publication
(10) Pub. No.: US 2002/0140684 A1
(43) Pub. Date: Oct. 3, 2002

(54) Stylus for personal digital assistant

(76) Inventors: Chien-Min Lin, Junghe City (TW); Ta-Wei Liu, Taipei (TW)

Correspondence Address: RABIN & CHAMPAGNE, PC, 1101 14TH STREET, NW, SUITE 500, WASHINGTON, DC, 20005, US

(21) Appl. No.: 09/908,655

(22) Filed: Jul. 20, 2001

(30) Foreign Application Priority Data
Mar. 29, 2001 (TW) 90204880

(51) Int. Cl. G09G 5/00

(52) U.S. Cl. 345/179

(57) ABSTRACT

A stylus for personal digital assistants including a stylus's body and a stabilizer is provided. The stylus's body is elliptically cylindrical with oval cross-section and has a central line, while the stabilizer is located inside the stylus's body but deviates from the central line. Among which, the stabilizer is located on the major axis of the oval cross-section shifting the position of the center of gravity of the stylus off the central line. Thus the stylus acquires more stability and will not roll around when placed on the desktop, providing handiness and convenience for the user to pick it up from the desktop.

This application incorporates by reference Taiwanese application Serial No. 90204880, Filed Mar. 29, 2001.

### BACKGROUND OF THE INVENTION

1. Field of the Invention

The invention relates in general to a stylus for personal digital assistants, and more particularly to a stylus, which stably lies on the desk allowing the users to pick up and use conveniently, for personal digital assistants.

2. Description of the Related Art

In today's society where technology advances and changes rapidly, modem people who are busy with their business and are in pursuit of high efficiency have changed from using conventional diaries to the use electronic diaries. Among which, the Personal Digital Assistant (PDA) is people's favorite. This is because the PDA is light in weight and easy to start, highly expandable and has a complete range of accessories allowing the users to install various kinds of application software to meet their needs. The users can arrange their schedules, search for business card details and telephone numbers, have a browse of outstanding businesses, take immediate memos, receive and send e-mails, and play games with the multi-functional PDA. The structure of the PDA will be illustrated as follows.

Please refer to FIG. 1, a three-dimension block diagram according to a conventional PDA. The PDA 100 in FIG. 1 includes a base unit 102, a display panel 104, three control buttons 106 and a stylus 108. The display panel 104 is located at a chamber 110 on the base unit's top face 109 of the base unit 102. The display panel 104 can be a Liquid Crystal Display (LCD), while the control buttons 106 are located on the base unit's top face 109 for users to operate with. Among which, the stylus 108 slides into a pen slot 112 of the base unit 102 along with the direction of an arrow 150 shown in FIG. 1, lest the stylus 108 might be misplaced. Using the stylus 108, the users can operate the PDA 100 easily. They just need to input personal messages into the PDA 100 by touching the display panel 104 lightly.

When using the PDA 100, the users tend to leave the stylus on the desk (not shown here) lest the stylus 108 be inserted into and removed from the pen slot 112 oftently. The users also find it handy and time saving to pick up the stylus 108 in this way. Normally the stylus 108 is light in weight and cylindrical in outlook, therefore it rolls around on the desk easily. An easy and handy access to the stylus 108 is always unavailable to the users.

### SUMMARY OF THE INVENTION

It is therefore an object of the invention to provide personal digital assistants with a stylus, whose design of a stabilizer and an elliptically cylindrical body allows the the-position of the center of gravity to deviate from the central line of the stylus, which acquires more stability and will not roll around when placed on the desktop. Thus the users find it convenient and handy to pick up the stylus from the desktop.

According to the object of the invention a stylus is provided, comprising a stylus's body and a stabilizer, wherein the stylus's body is elliptically cylindrical with oval cross-section; the stylus's body has a central line, while the stabilizer is located inside the stylus's body but deviates from the central line. Among which, the stabilizer is located on the major axis of the oval cross-section shifting the position of the center of gravity of the stylus off the central line.

According to the object of the invention another stylus for PDAs is provided, comprising a stylus's body and a stabilizer, wherein the stylus's body is elliptically cylindrical with oval cross-section; the stylus's body has a central line, while the stabilizer is located inside the stylus's body but deviates from the central line. Among which, the stabilizer is located on the major axis of the oval cross-section shifting the center-of gravity position of the stylus off the central line.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A is a three-dimensional block diagram of a conventional PDA;

FIG. 2A is a block diagram of a stylus for a PDA according to a preferred embodiment of the invention; and

FIG. 2B is a section view of a stylus along the section line 2B-2B in FIG. 2A.

### DESCRIPTION OF THE PREFERRED EMBODIMENT

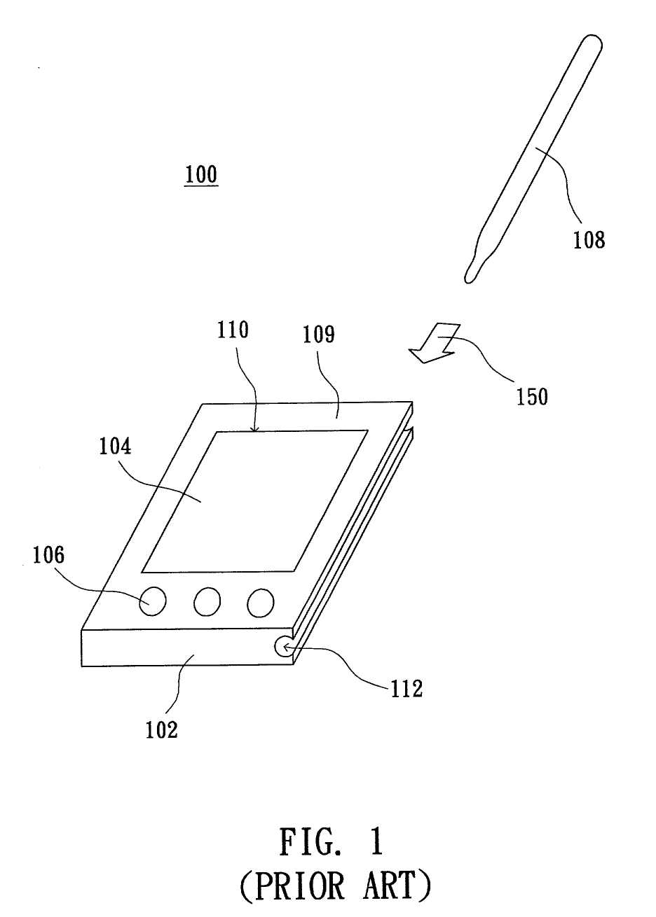

The invention particularly adds a stabilizer to the stylus of Personal Digital Assistant (PDA). The stabilizer is located inside the stylus and off the central line of the body of the stylus. By doing so, the stylus acquires more stability and will not roll around when placed on the desk. Thus the users find it convenient and handy to pick up the stylus from the desk. As for the practical application of the stylus according to the invention will be illustrated by means of a preferred embodiment. Meanwhile, the PDA according to the invention does not differ from that shown in FIG. 1 other than the stylus, so there is no need to repeat it here.

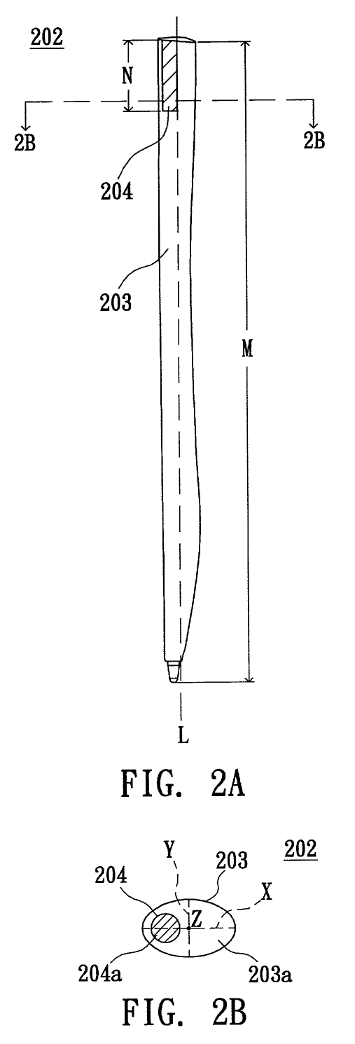

Referring first to FIG. 2A is a block diagram of a stylus for a PDA according to a preferred embodiment of the invention is shown. The stylus 202 according to the invention as shown in FIG. 2A is used by the users to input messages into the PDA. The stylus 202 differs from the stylus 108 in FIG. 1 in that the stylus 202 has a stylus's body 203 as well as a stabilizer 204, wherein the stylus's body 203 is an elliptical cylinder and the stabilizer is round stick shaped. The stylus's body has a central line representing the position of the center of gravity of the stylus 202 before the stabilizer 204 is installed. Whereas the stabilizer 204 is installed inside the stylus's body 203 and is at one side of the central line L of the stylus's body 203, resulting in a shift of the position of the center of gravity from the central line L towards the stabilizer 203. That is, the position of the center of gravity of the stylus 202 is located at one side of the central line L. For instance, if the stabilizer is located at the left side of the central line L, the position of the center of gravity of the stylus 202 will be at the left side of the central line L as shown in FIG. 2B, a sectional view along the section line 2B-2B in FIG. 2A.

It is noteworthy that the cross section of the stylus's body 203 is an oval cross-section 203a. The major axis X and minor axis Y of the oval cross-section 203a cross at the central point Z, the point where the central line L in FIG. 2A passes through. Whereas the cross section of the stabilizer 204 is a circular cross-section 204a, which is located on the major axis X of oval cross-section 203a but deviates from the central point Z of oval cross-section 203a. That is, the stabilizer 204 is located on the major axis X of oval cross-section 203a but deviates from the central point Z of oval cross-section 203 a.

Please refer to FIG. 2A and FIG. 2B at the same time. When the user places the stylus 202 on the desk, the stylus 202 tends to roll towards the stabilizer side due to its skewed position of the center of gravity. Therefore the stylus 202 stands still soon after coming into contact with the desktop. In the meanwhile, of the two ends of the major axis X of the oval cross-section 203a, the particular one, which is closest to the stabilizer 204, comes into contact with the desktop, causing the major axis X of the oval cross-section 203a to become perpendicular to the desktop. Since the stylus 202 lies on the desktop with its ridged part facing upward, the user finds it easier and handy to pick it up from the desktop.

Those who are familiar with the skills and technology of the invention will understand that the invention is not limited to the disclosed embodiment. For instance, the stabilizer 204 can be lump-shaped or made of metals. The length of the stabilizer 204 measures N, while that of the stylus measures M. N can be shorter than M.

According to the invention, a stylus for personal digital assistants is disclosed in the above-mentioned preferred embodiments. Its design of a stabilizer and an elliptically cylindrical body allows the the-position of the center of gravity to deviate from the central line of the stylus, which acquires more stability and will not roll around when placed on the desktop. Thus the users find it convenient and handy to pick up the stylus from the desktop.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stylus, comprising:
a stylus's body, which is elliptically cylindrical with oval cross-section and a central line; and
a stabilizer, which is located inside the stylus's body but deviates from the central line, situated on the major axis of the oval cross-section causing the position of the center of gravity of the stylus to shift off the central line.

2. The stylus according to claim 1, wherein the stabilizer is a round stick with circular cross-section.

3. The stylus according to claim 1, wherein the stabilizer is made of metals.

4. The stylus according to claim 1 is an attachment of a Personal Digital Assistant (PDA).

5. A stylus for PDA, comprising:
a stylus's body, which is elliptically cylindrical with oval cross-section and a central line; and
a stabilizer, which is located inside the stylus's body but deviates from the central line, situated on the major axis of the oval cross-section causing the position of the center of gravity of the stylus to shift off the central line.

6. The stylus according to claim 5, wherein the stabilizer is a round stick with circular cross-section.

7. The stylus according to claim 5, wherein the stabilizer is made of metals.
